(19) United States
(12) Patent Application Publication
(10) Pub. No.: US 2014/0373520 A1
(43) Pub. Date: Dec. 25, 2014

(54) SYSTEM AND METHOD FOR MAINTAINING CONSTANT LOADS IN HYDRAULIC SYSTEMS

(71) Applicant: EATON CORPORATION, Cleveland, OH (US)

(72) Inventor: Wade Leo Gehlhoff, Shakopee, MN (US)

(73) Assignee: Eaton Corporation, Cleveland, OH (US)

(21) Appl. No.: 14/375,868

(22) PCT Filed: Jan. 16, 2013
(86) PCT No.: PCT/US2013/021658

§ 371 Date: Jul. 31, 2014

Related U.S. Application Data
(60) Provisional application No. 61/593,072, filed on Jan. 31, 2012.

(51) Int. Cl. F15B 11/08; F15B 13/04

(52) U.S. Cl. CPC F15B 11/08; F15B 13/04
USPC 60/327; 60/459; 60/328

(57) ABSTRACT

A hydraulic system includes a pump (22) that draws fluid from a reservoir (24) and an actuator (26) having a first port and a second port. A metering valve arrangement (28) controls fluid flow through the actuator and includes a meter-in valve (30a, 30d) positioned between the pump and the first port and a meter-out valve (30b, 30c) positioned between the second port and the reservoir. A controller (34) controls operation of the metering valve arrangement. In a meter-in mode, the controller controls a fluid flow rate through the actuator by controlling an orifice size of the meter-in valve. In a meter-out mode, the controller controls a fluid flow rate through the actuator by controlling an orifice size of the meter-out valve. The controller determines the fluid flow rate through the actuator based on data derived from the meter-out valve in both the meter-in mode and the meter-out mode.

### CROSS-REFERENCE TO RELATED APPLICATIONS

This application is being filed on 16 Jan. 2013, as a PCT International Patent application and claims priority to U.S. Patent Application Ser. No. 61/593,072 filed on 31 Jan. 2012, the disclosure of which is incorporated herein by reference in its entirety.

### BACKGROUND

In hydraulic systems, meter-in and meter-out elements are used to control operation of hydraulic actuators. Meter-in control valves restrict the flow of hydraulic fluid from a pump into an actuator inlet. In that case, they are only used in systems where opposing loads are present, since they cannot prevent a load from running away. Meter-out control valves restrict the flow of hydraulic fluid out of an actuator. Since these valves regulate the flow evacuating the system, they are able to prevent a run-away load and maintain load control. When transitioning loads, the valve that is controlling the velocity of the load is required to change from meter-in to meter-out (or from meter-out to meter-in). Any difference in the accuracy of metering elements results in a change in speed of the load, which can create an undesirable or even unsafe condition.

### SUMMARY

In one aspect, the technology relates to a hydraulic system including: a pump that draws fluid from a reservoir; an actuator having a first port and a second port; a metering valve arrangement that controls fluid flow through the actuator, the metering valve arrangement including a meter-in valve positioned between the pump and the first port and a meter-out valve positioned between the second port and the reservoir; and a controller that controls operation of the metering valve arrangement, the hydraulic system being operable in a meter-in mode in which the controller controls a fluid flow rate through the actuator by controlling an orifice size of the meter-in valve, the hydraulic system being operable in a meter-out mode in which the controller controls a fluid flow rate through the actuator by controlling an orifice size of the meter-out valve, and where the controller determines the fluid flow rate through the actuator based on data derived from the meter-out valve in both the meter-in mode and the meter-out mode.

In another aspect, the technology relates to a method of controlling a hydraulic system, the method including: operating the hydraulic system in a meter-in mode, wherein a flow of hydraulic fluid to the hydraulic actuator is controlled by actuating a meter-in valve; detecting an inlet load at the hydraulic actuator; detecting an outlet load at the hydraulic actuator; and operating the hydraulic system in a meter-out mode, wherein a flow of hydraulic fluid from the hydraulic actuator is controlled by actuating a meter-out valve, when the output load is greater than the input load.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 is a schematic diagram of a hydraulic control system.

FIG. 2 is a schematic diagram of the hydraulic control system of FIG. 1.

FIG. 3 is a schematic diagram of the hydraulic control system of FIG. 1.

FIG. 4 depicts an excavator utilizing a hydraulic control system.

FIG. 5 depicts a method of controlling a hydraulic system.

### DETAILED DESCRIPTION

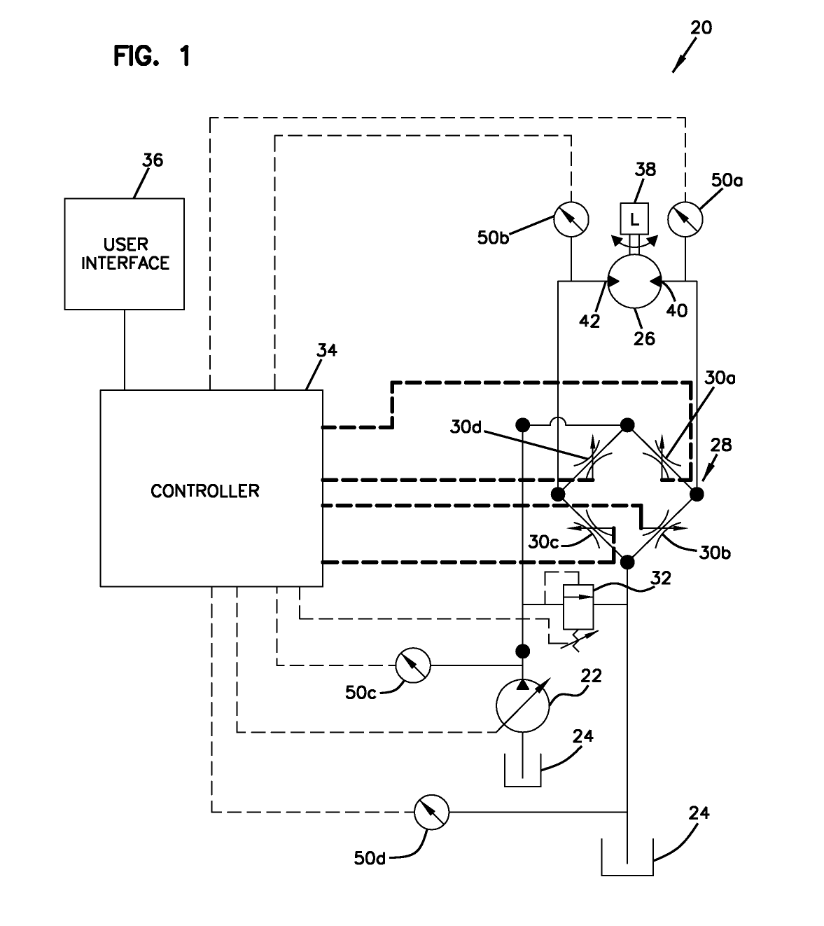

FIG. 1 shows a hydraulic system 20 in accordance with the principles of the present disclosure. The hydraulic system 20 includes a pump 22 (e.g., a variable displacement pump) that draws fluid from a reservoir 24. Hydraulic fluid discharged from the pump 22 is used to drive an actuator 26. In the depicted embodiment, the actuator 26 is a bidirectional hydraulic motor, but in other embodiments could be a hydraulic cylinder or other structure. A valve arrangement 28 is used to control fluid communication between the pump 22 and the actuator 26, and also between the actuator 26 and the reservoir 24. The valve arrangement 28 includes a first valve 30a, a second valve 30b, a third valve 30c and a fourth valve 30d. The valves 30a-30d are preferably variable orifice valves. A relief valve 32 is positioned between the pump 22 and the valve arrangement 28. If the hydraulic pressure at the output of the pump 22 exceeds a limit set by the relief valve 32, the relief valve 32 dumps a portion of the hydraulic flow from the pump 22 to the reservoir 24 to prevent the hydraulic pressure provided to the valve arrangement 28 from exceeding the predetermined limit. The system 20 further includes a controller 34 that controls operation of the valve arrangement 28, the relief valve 32 and the pump 22. A user interface 36 allows an operator to generate operator control signals that are conveyed to the controller 34. In certain embodiments, the user interface 36 can include joy sticks, levers, control buttons, keyboards, other interface structures, or combinations thereof. As depicted at FIG. 1, the actuator 26 is used to drive a load 38.

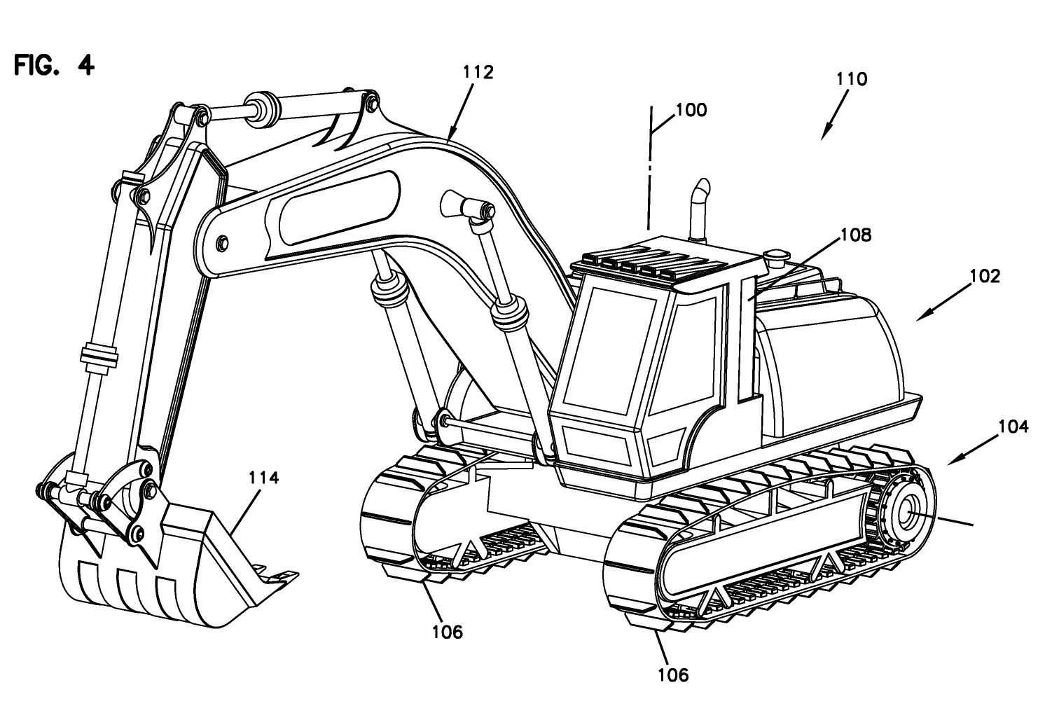

In one embodiment, the actuator 26 is used on an excavator 100 (see FIG. 4). The excavator 100 includes an upper assembly 102 that mounts on an undercarriage 104. The undercarriage 104 includes propulsion structures 106 such as tracks or wheels used to propel the excavator 100 along the ground. The undercarriage 104 can also include an undercarriage frame, and one or more drives for powering the propulsion structures 106. The upper assembly 102 can include a cab 108. Typically, the upper assembly 102 attaches to the undercarriage 104 by way of a center pin that allows the upper assembly 102 to rotate 360 degrees about a vertical axis 110 relative to the undercarriage 104. A swing drive (i.e., a slew drive) is used to rotate the upper assembly 102 relative to the undercarriage 104 about the vertical axis 110. The upper assembly 102 can also include an excavator arm 112. The excavator arm 112 is typically articulated and includes an excavating element such as a bucket 114 at its free end. The actuator 26 can be used to pivot/rotate the upper assembly 102 of the excavator 100 about the vertical axis 110 relative to an undercarriage 104 of the excavator 100. Thus, in such an embodiment, the actuator 26 functions as a swing drive (i.e., a slew drive) and the load 38 represents the power required to rotate the upper assembly 102 of the excavator 100 about the vertical axis 110 at a selected rotational speed.

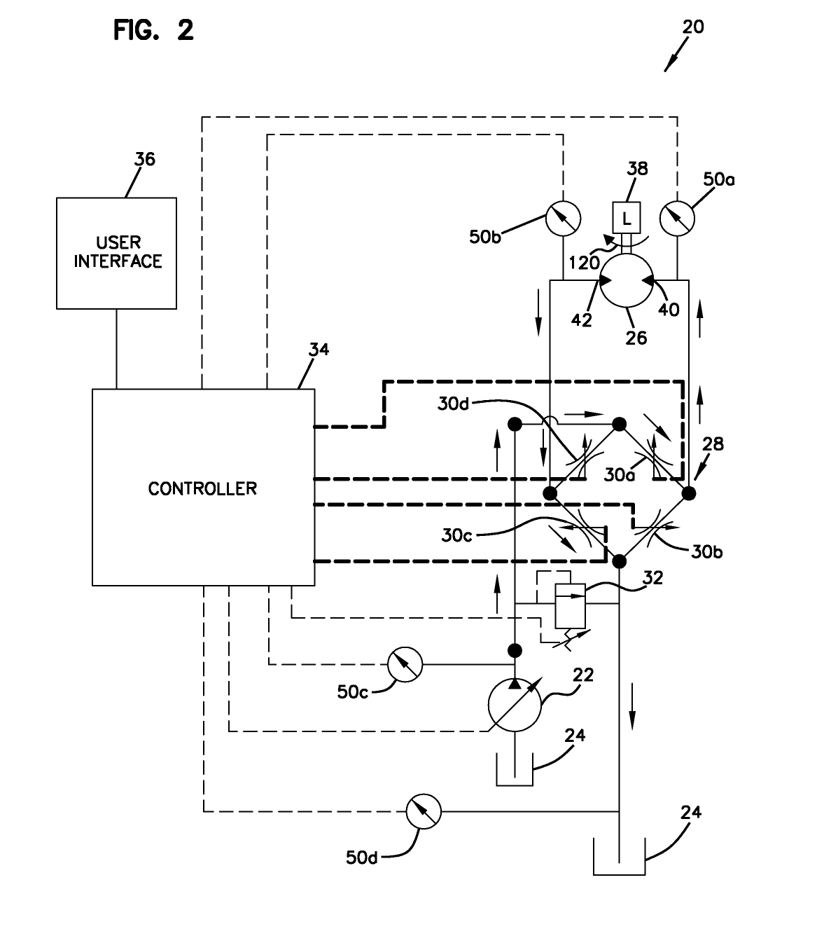

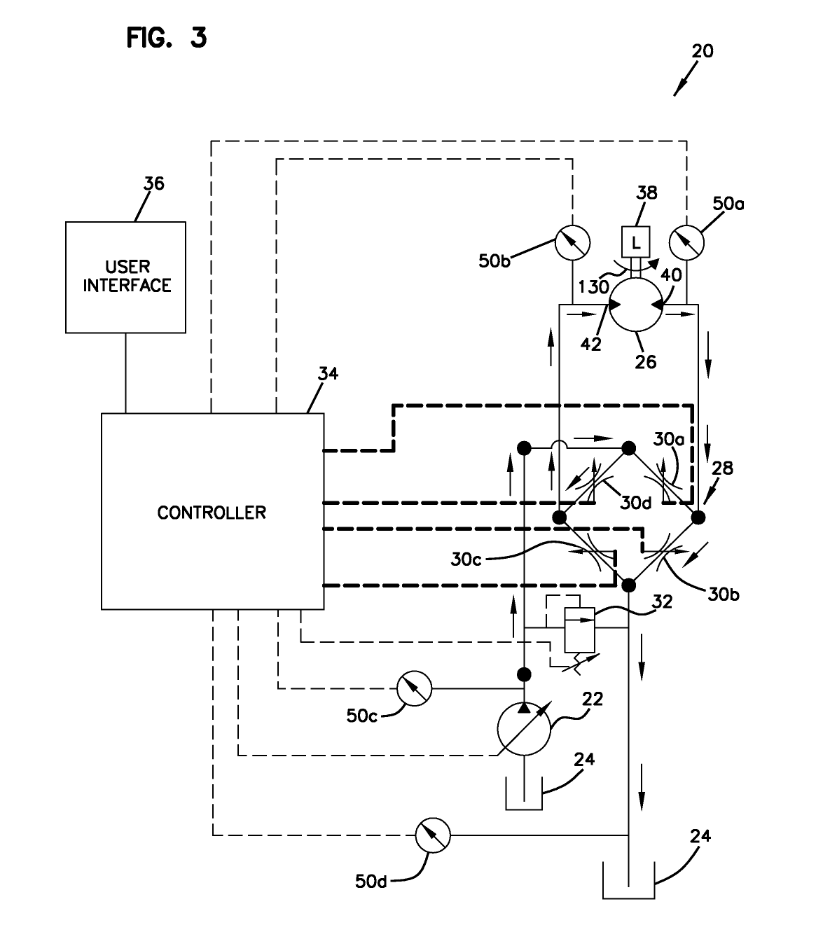

Referring to FIGS. 1-3, the actuator 26 includes a first port 40 and a second port 42. Since the actuator 26 is bidirectional, the first and second ports 40, 42 can alternate relative to one another between being input ports and output ports. For example, when the load 38 is rotated in a first direction 120 as shown at FIG. 2, the first port 40 is an input port in fluid communication with the pump 22 and the second port 42 is an output port in fluid communication with the reservoir 24. In contrast, when the load 38 is rotated in a second direction as shown at FIG. 3, the second port 42 is an input port in fluid communication with the pump 22 and the first port 40 is an output port in fluid communication with the reservoir 24.

It will be appreciated that the system 20 can be operated in a meter-in mode and a meter-out mode. The system 20 operates in the meter-in mode when the hydraulic pressure at the input port of the actuator 26 is greater than the hydraulic pressure at the output port of the actuator 26. This occurs when power from the pump 22 is being used to actively drive the load 38 via the actuator 26. The system 20 operates in the meter-out mode when the hydraulic pressure at the output port of the actuator 26 is greater than the hydraulic pressure at the input port of the actuator 26. This condition occurs when the effects of gravity or other means causes the load 38 to be moved in an over-run condition.

FIG. 2 shows the system 20 with the load 38 rotating in the first direction 120. With the load 38 rotating the first direction 120, the first valve 30a is a meter-in valve, the third valve 30c is a meter-out valve, and the second and fourth valves 30b, 30d are closed. In the meter-in mode, hydraulic fluid from the pump 22 is used to drive the actuator 26 and an orifice size of the first valve 30a is controlled by the controller 34 to provide a metering function that causes a desired flow rate through the actuator 26. The desired flow rate preferably corresponds to a rotational speed at which it is desired to rotate the load 38. In the event the load 38 begins to overrun because of the effect of gravity, the hydraulic pressure at the second port 42 becomes greater than the hydraulic pressure at the first port 40. This variation in pressure can be detected by pressure sensors 50a, 50b positioned on opposite sides of the actuator 26. When the hydraulic pressure at the second port 42 exceeds the hydraulic pressure at the first port 40, the system 20 switches from the meter-in mode to the meter-out mode. In the meter-out mode, the controller 32 controls the orifice size of the third valve 30c to control the flow rate through the actuator 26. In this way, it will resist the effects of gravity, and the load 38 can continue to be rotated at a constant rotational speed. The system 20 can also include pressure sensors 50c and 50d. The pressure sensor 50c measures a system pressure of the system 20 at an output location of the pump 22. The pressure sensor 50d measures a tank pressure of the system 20. All of the sensors 50a-50d preferably interface with the controller so as to provide the controller with the real-time pressure data.

As indicated above, the rotational speed of the load 38 is dependant upon the flow rate of hydraulic fluid through the actuator 26. The controller 34 determines the flow rate through the actuator 26 based on data derived from the meter-out valve (i.e., the third valve 30c) in both the meter-in mode and the meter-out mode. For example, based on the orifice size of the third valve 30c and the pressure readings from the pressure sensors 50b and 50d, the controller can calculate or otherwise determine a flow rate value corresponding to the flow through the actuator 26. It is significant that the data used to determine the flow rate through the actuator 26 is derived from the third valve 30c regardless of whether the hydraulic system is operating in the meter-in mode or the meter-out mode. This is significant because there can be differences in accuracy between different metering elements. Thus, if data from different metering elements were to be used to calculate the velocity when switching between meter-in and meter-out modes, the differences in accuracy between the two metering elements can result in undesired changes in the rotational velocity of the load 38. By using data only from the third valve 30c in both the meter-in mode and the meter-out mode, such inaccuracies are eliminated.

FIG. 3 shows the load 38 being rotated in the second direction 130. When the load 38 is rotated in the second direction, the second port 42 is an input port, the first port 40 is an output port and the first and third valves 30a, 30c are closed. The fourth valve 30d controls fluid communication between the pump 22 and the second port 42 and the second valve 30b controls fluid communication between the first port 40 and the reservoir 24. In the meter-in mode, the orifice size of the fourth valve 30d is controlled to provide a desired flow rate to the actuator 26 that corresponds to a desired rotational speed of the load 38. In the event of an overrun condition, the controller 34 senses that the pressure at the first port 40 is greater than the pressure at the second port 42, and switches the system to the meter-out mode. In the meter-out mode, the second valve 30b functions as a metering valve that controls the flow rate through the actuator 26. In this mode, the controller controls the orifice size of the second valve 30b such that the desired flow rate through the actuator 26 is maintained. When the load 38 is rotating in the second direction 130, the controller 34 uses data derived from the second valve 30b (i.e., the meter-out valve) regardless of whether the system 20 is in the meter-in mode or the meter-out mode). As described above, by using flow data derived only from the meter-out valve, the rotational speed of the load 38 can be more accurately controlled during load transitions.

In use of the system, an operator generates a control signal at the user interface 36. The speed control signal indicates the direction the operator wants the load 38 to rotate, and also indicates the speed at which the operator wants the load 38 to rotate. The controller 34 receives the control signal and operates the valve arrangement 28 and the pump 22 to drive the load 38 at the rotational speed and in the rotational direction desired by the operator. To insure that the actuator 26 is rotated at the desired speed and direction, the controller monitors the flow rate through the actuator 26. The flow rate through the actuator is determined based on data derived from a meter-out valve regardless of whether the system 20 is in the meter-in mode or the meter-out mode. Such data can be determined in a number of ways. Flow through the valves 30a-30d may be directly measured with flow rate sensors. Alternatively, flow may be estimated based on position of a valve controller, valve actuator current, fluid pressure at locations within the system, or combinations thereof.

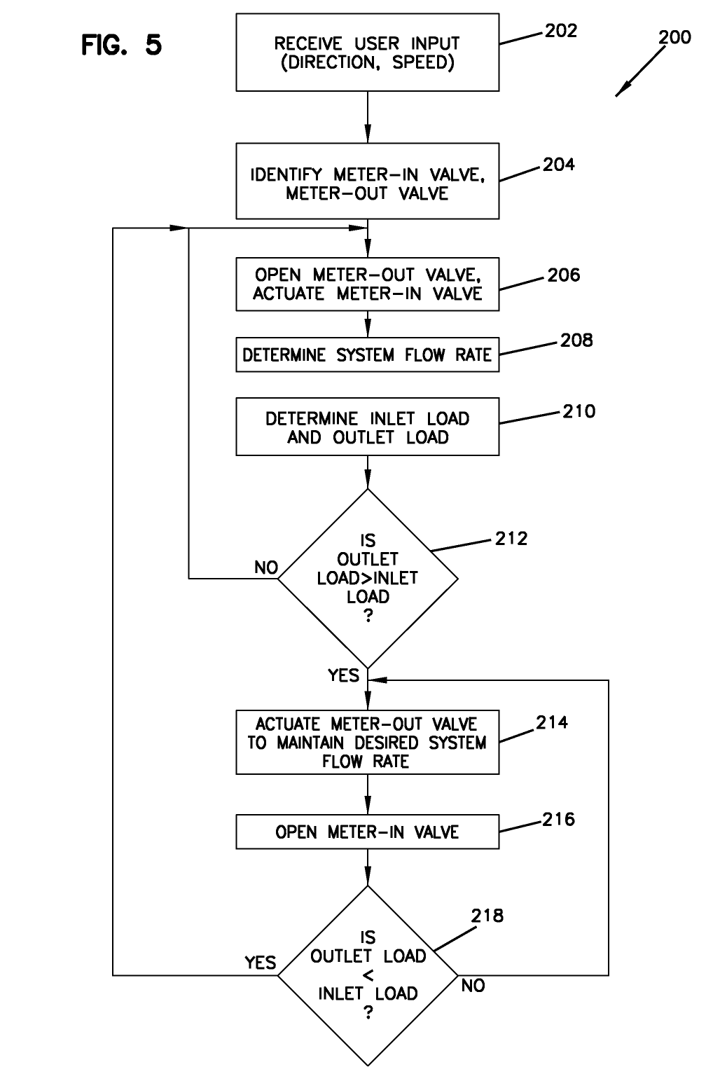

FIG. 5 depicts a method of controlling a hydraulic system 200. The method may be practiced by an algorithm and includes receiving an input from a user interface (Step 202). The input may include signals representative of control direction, desired speed, etc. The desired direction input dictates which port of a hydraulic actuator is the input port, and which port is the output port. The meter-in valve and meter-out valve are then identified based on the location of the input port and the output port (Step 204). The meter-in valve is located between a hydraulic pump and the actuator inlet; the meter-out valve is located between the actuator outlet and the fluid reservoir. In the meter-in mode, the meter-out valve is opened fully, while flow of hydraulic fluid to the actuator is controlled based on actuation of the meter-in valve (Step 206). The actual system flow rate is determined at or near the meter-out valve (Step 208). This measured or calculated value is compared to the desired flow rate (as based on the user input) and the meter-in valve actuated accordingly. The actuator inlet and outlet loads are also monitored (Step 210). If the inlet load remains higher than the outlet load, the system remains in meter-in mode (and returns to Step 206). If the outlet load is greater than the inlet load (Step 212), that is indicative of a runaway load (i.e., a load moving in the same direction as the force applied by the actuator). Such a load change initiates a change from meter-in mode to meter-out mode. In meter-out mode, the meter-out valve is first actuated to maintain the desired system flow rate (Step 214). Thereafter, the meter in valve is opened (Step 216). Monitoring of the inlet and outlet load continues and, if the outlet load remains greater than the inlet load (Step 218), actuation of the meter-out valve continues (i.e., return to Step 214). If the inlet load is less than the outlet load, the algorithm returns to meter-in mode (returns to Step 206), and continues to actuate the meter-in valve as needed. At any time during this process, a change in command direction will necessitate a change in valve configuration (that is, the valve previously designated as the meter-in valve will be designated as the meter-out valve when command direction changes). This would return the control algorithm to Step 202. As described above, flow rate is measured at the meter-out valve, regardless of whether the system is in meter-in mode or meter-out mode.

The hydraulic control system described above may be sold as a kit, either in a single package or in multiple packages. A kit may include a controller, pressure sensors, pump, valve, etc. Alternatively, the controller may be sold as a single stand-alone unit. Users may then obtain the various valves, sensors, etc., separately from a third party or from the pump supplier. If desired, control wiring may be included, although instructions included with the kit may also specify the type of wiring required based on the particular installation.

Additionally, the electronic controller may be loaded with the necessary software or firmware required for use of the system. In alternative configurations, software may be included on various types of storage media (CDs, DVDs, USB drives, etc.) for upload to a standard PC, if the PC is to be used as the controller, or if the PC is used in conjunction with the control or pump system as a user or service interface. Additionally, website addresses and passwords may be included in the kit instructions for programs to be downloaded from a website on the internet.

The control algorithm technology described herein can be realized in hardware, software, or a combination of hardware and software. The technology described herein can be realized in a centralized fashion in one computer system or in a distributed fashion where different elements are spread across several interconnected computer systems. Any kind of computer system or other apparatus adapted for carrying out the methods described herein is suitable. A typical combination of hardware and software can be a general purpose computer system with a computer program that, when being loaded and executed, controls the computer system such that it carries out the methods described herein. Since the technology is also contemplated to be used on heavy construction equipment, however, a stand-alone hardware system including the necessary operator interfaces may be desirable.

The technology described herein also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A hydraulic system comprising:
a pump that draws fluid from a reservoir;
an actuator having a first port and a second port;
a metering valve arrangement that controls fluid flow through the actuator, the metering valve arrangement including a meter-in valve positioned between the pump and the first port and a meter-out valve positioned between the second port and the reservoir; and
a controller that controls operation of the metering valve arrangement, the hydraulic system being operable in a meter-in mode in which the controller controls a fluid flow rate through the actuator by controlling an orifice size of the meter-in valve, the hydraulic system being operable in a meter-out mode in which the controller controls a fluid flow rate through the actuator by controlling an orifice size of the meter-out valve, and where the controller determines the fluid flow rate through the actuator based on data derived from the meter-out valve in both the meter-in mode and the meter-out mode.

2. The hydraulic system of claim 1, wherein the actuator may be actuated in a first direction and a second direction.

3. The hydraulic system of claim 2, wherein when the actuator is actuated in the first direction, fluid flow passes from the first port to the second port.

4. The hydraulic system of claim 2, wherein when the actuator is actuated in the second direction, fluid flow passes from the second port to the first port.

5. The hydraulic system of claim 1, further comprising a user interface for sending a control signal to the controller.

6. The hydraulic system of claim 1, wherein the user interface comprises at least one of a joy stick, a lever, a control button, and a keyboard.

7. The hydraulic system of claim 1, wherein each of the meter-in valve and the meter-out valve comprises a variable orifice valve.

8. A method of controlling a hydraulic system, the method comprising:
operating the hydraulic system in a meter-in mode, wherein a flow of hydraulic fluid to the hydraulic actuator is controlled by actuating a meter-in valve;
detecting an inlet load at the hydraulic actuator;
detecting an outlet load at the hydraulic actuator; and
operating the hydraulic system in a meter-out mode, wherein a flow of hydraulic fluid from the hydraulic actuator is controlled by actuating a meter-out valve, when the output load is greater than the input load.

9. The method of claim 8, further comprising determining, in both the meter-in mode and the meter-out mode, a flow rate through the hydraulic system based at least in part on a signal sent from a sensor located at the meter-out valve.

10. The method of claim 9, wherein the sensor comprises at least one of a flow-rate sensor, a valve controller position sensor, a valve actuator current sensor, and a fluid pressure sensor.

11. The method of claim 8, wherein each of the meter-in valve and the meter-out valve comprise a variable orifice valve.

12. The method of claim 8, further comprising receiving a control signal from a user interface.

13. The method of claim 8, wherein the hydraulic actuator is operable in both a first direction and a second direction.
